(19) United States
(12) Patent Application Publication
(10) Pub. No.: US 2022/0242698 A1
(43) Pub. Date: Aug. 4, 2022

(54) IMPROVEMENTS IN OR RELATING TO STAIRLIFTS

(71) Applicant: Stannah Stairlifts Limited, Hampshire (GB)

(72) Inventor: Andreas Csaba Szentistvany, Hampshire (GB)

(21) Appl. No.: 17/625,963

(22) PCT Filed: Jul. 7, 2020
(86) PCT No.: PCT/GB2020/051625

§ 371 Date: Jan. 10, 2022

(30) Foreign Application Priority Data
Jul. 9, 2019 (GB) 1909853.2

(51) Int. Cl. B66B 9/08

(52) U.S. Cl. CPC B66B 9/0807; B66B 9/0846; B66B 9/0838

(57) ABSTRACT

A friction drive stairlift has a single drive wheel mounted to rotate in a plane passing through the centreline of the stairlift rail. The rail is preferably formed from two parallel tubes and a facility to maintain the chair level as the stairlift passes through a transition bend is preferably mounted on the same axis as the friction drive wheel.

### CROSS-REFERENCE TO RELATED APPLICATIONS

This application is the U.S. National Stage of PCT/GB2020/051625 filed Jul. 7, 2020, which claims priority to United Kingdom Patent Application No. 1909853.2 filed Jul. 9, 2019, the content of both of which are incorporated herein by reference in their entirety.

### FIELD OF THE INVENTION

This invention relates to stairlifts and, in particular, to a stairlift in which the stairlift rail includes changes in inclination and/or direction. Such a stairlift is commonly referred to as a curved stairlift and is contrasted with a straight stairlift in which the rail is at a single, fixed, angle of inclination.

### BACKGROUND TO THE INVENTION

Numerous forms of curved stairlift are available today which meet the needs and wishes of users in a variety of ways. In general, there is an increasing demand not only for functionality but also in ease of manufacture, installation and maintenance; and also, for factors such as ride quality and aesthetics.

The majority of stairlifts currently available include a rack and pinion drive arrangement. Such a drive arrangement is robust and reliable but certain limitations arise from its use. For example, rail sections must be provided in lengths that are multiples of the tooth pitch of the rack, and it is not always possible to accurately match the pitch when joining rail sections together. As a consequence ride quality, which in any event is not optimum in rack and pinion drives, suffers and the problem increases with increasing carriage speed. Given the desire to maintain carriage speed as close as possible to the maximum allowable 0.15 m/sec, the ride quality problem is a significant drawback with rack and pinion drives. Further, there are limitations in bend radii that can be achieved because the changes in tooth pitch and/or alignment in bends may be such as to cause meshing problems with the drive pinion. Friction drive has been proposed as an alternative to rack and pinion drive. U.S. Pat. No. 2,888,099 describes a friction drive stairlift in which multiple drive wheels on a common drive axis are biased into contact with the top plate of angle-sectioned rail. Relative rotation between the chair and the carriage, in order to maintain the chair level as it passes through transition bends, is effected by a mechanical linkage acting on a levelling bar fixed to, and extending along, the rail. While it is disclosed within the body of the patent that the described stairlift could be configured to include bends in a horizontal plane, also called inside/outside bends, this bend type is not depicted or described and, because of the rail section and the broad width of the drive wheel, any horizontal bend would have to be of such a large radius as to make the stairlift impractical for fitment to the staircase of a domestic dwelling.

Another form of friction drive stairlift is described in British Patent GB 2 379 209 granted to the present applicant. In this patent the rail is a twin tube arrangement with the stairlift carriage being clamped to the upper tube by what is commonly referred to as a skate. The carriage further includes a support roller which bears against the lower tube to prevent the carriage and chair assembly from pitching forward or rotating about the lengthwise directional axis of the rail. Since the carriage remains vertical at all times, there is a limitation on the rail angle that can be accommodated since, as the rail angle steepens, contact between the lower support roller and the bottom rail tube reduces. This means that a rail configuration such as that described in published International Patent Applications WO 2005/085114 and WO 2017/187161 could not be realised as the bottom support roller would be completely out of contact with the lower rail tube. A further problem with the stairlift described in this patent is that, in inside/outside bends, the drive roller scrubs laterally across the surface of the upper tube which gives rise to increased wear.

It is an object of the invention to provide a friction drive stairlift which will go at least some way in addressing the aforementioned problems; or which will at least provide a novel and useful choice.

### SUMMARY OF THE INVENTION

Accordingly, in a first aspect, the invention provides a stairlift including a rail having a length direction axis, a carriage mounted on said rail for movement there-along; and a chair mounted on said carriage, said carriage having a carriage axis that is arranged perpendicular to the direction of the rail at any position of the carriage along the rail wherein the carriage is positioned on the rail by a single drive roller configured to frictionally engage the rail and a plurality of biasing rollers in contact with the rail and positioned to maintain the drive roller in contact with the rail, a plane passing through the centre of said drive roller, perpendicular to the axis of rotation of the drive roller, passing through a centreline of the rail at any position of the carriage on the rail, said carriage further including biasing means to apply a clamping bias effective to clamp said drive roller and said biasing rollers against said rail; and means to resist rotational movement of said carriage about said length direction axis.

Preferably said rail is defined by two spaced tubes which, when the rail is mounted for use, are arranged substantially above one another, said drive roller and said biasing rollers engaging opposed edges of one of said tubes.

Preferably the drive roller and said biasing rollers engage an upper tube of said two spaced tubes.

Preferably the two tubes are substantially evenly spaced along the length of said rail.

Preferably said means to resist rotational movement of said carriage about said length direction axis comprises a plurality of support rollers engaging a lower tube of said two spaced tubes.

Preferably, when viewed in vertical cross-section along said length direction axis, a contact surface of said drive roller has substantially the same form as that part of said rail in contact therewith.

Preferably said stairlift further includes a levelling facility configured and operable to effect relative rotation between said chair and said carriage as said carriage moves through a bend in said rail in a vertical plane to maintain said chair substantially level.

Preferably said drive roller rotates about a drive axis and wherein said levelling facility is configured to effect relative rotation between said chair and said carriage about said drive axis, at least one first motor being provided to rotate said drive roller and at least one second motor being provided to effect relative rotation between said chair and said carriage.

In a second aspect the invention provides a stairlift including a rail having a length direction axis, a carriage mounted on said rail for movement there-along; and a chair mounted on said carriage, said carriage having a carriage axis that is arranged perpendicular to the direction of the rail at any position of the carriage along the rail wherein said carriage includes a single drive roller configured to rotate about a drive axis and to frictionally engage said rail; biasing means to bias said drive roller against said rail and a levelling facility configured to effect relative rotation between said chair and said carriage about said drive axis as said carriage moves through a bend in the rail in a vertical plane, the carriage including at least one first motor to rotate said drive roller and at least one second motor to effect relative rotation between said chair and said carriage independently of said first motor.

Preferably said carriage including two second motors to effect rotation of said chair relative to said carriage.

Preferably, when viewed in a direction along said drive axis, said first motor applies drive substantially on said carriage axis and said two second motors apply drive on opposite sides of said carriage axis.

Preferably said rail includes a bend that, when viewed in plan view, has a bend radius of falling substantially in the range of 90 to 100 mm.

Preferably said drive roller has a drive surface formed from polyurethane having a shore harness falling in the range 92 to 95.

Preferably, when mounted in a stairway, said rail has an upper end and a lower end, a section of the rail terminating in said lower end being substantially vertical.

Many variations in the way the present invention can be performed will present themselves to those skilled in the art. The description which follows is intended as an illustration only of one means of performing the invention and the lack of description of variants or equivalents should not be regarded as limiting. Subject to the scope of the appended claims, wherever possible, a description of a specific element should be deemed to include any and all equivalents thereof whether in existence now or in the future.

### BRIEF DESCRIPTION OF THE DRAWINGS

One example only of a working embodiment of the invention will now be described with reference to the accompanying drawings in which:

FIG. 1: shows a general schematic layout view of a stairlift to which the various aspects of the invention may be applied;

FIG. 2: shows an isometric view, from the rear, of a stairlift carriage forming part of a stairlift according to the invention;

FIG. 3: shows a front elevational view of the carriage of FIG. 2 mounted on a horizontal section of rail;

FIG. 4: shows a similar view to FIG. 3 but viewed from the rear;

FIG. 5: shows a side elevational view of a sub-assembly carrying the biasing rollers of the carriage shown in FIGS. 2 to 4;

FIG. 6: shows an exploded isometric view of most of the components shown in FIG. 5;

FIG. 7: shows a front elevational view of the carriage shown in FIGS. 2 to 4 mounted on a section of rail that includes a transition bend;

FIG. 8: shows a plan view of the carriage shown in FIGS. 2 to 4 mounted on a section of rail that includes an inside bend;

FIG. 9: shows a side elevational view of the carriage shown in FIGS. 2 to 4 mounted on a section of rail; and

FIG. 10: shows a plan view of the carriage shown in FIGS. 2 to 4 passing through an inside bend.

### DETAILED DESCRIPTION OF WORKING EMBODIMENT

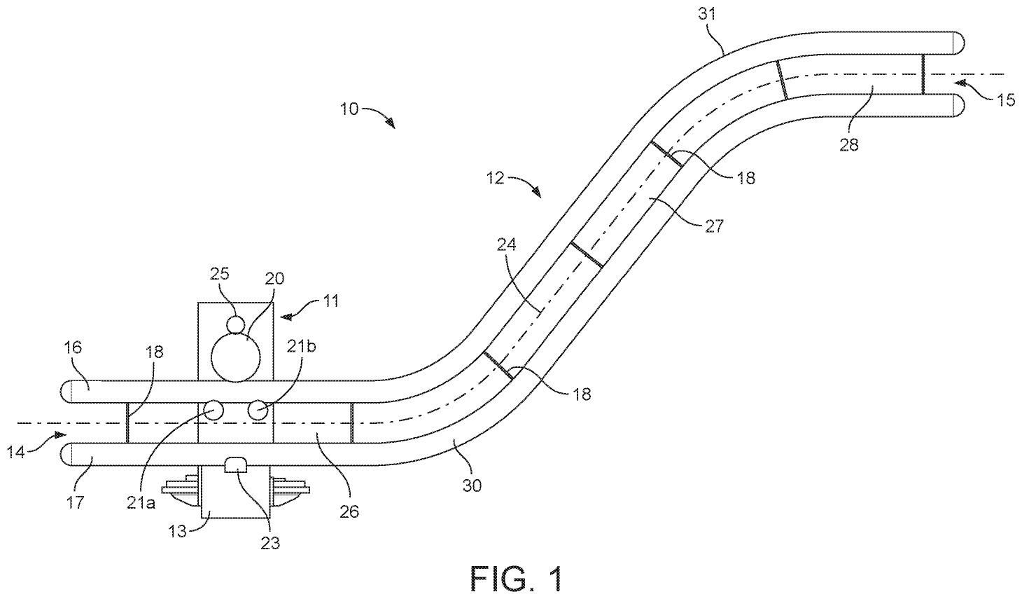

Referring firstly to FIG. 1, a stairlift 10 is shown comprising a carriage 11 mounted on rail 12. In the conventional manner the carriage mounts an interface 13 which, in turn, mounts a chair (not shown). A levelling facility, which will be described in more detail below, effects relative rotation between the interface and the carriage to maintain the chair substantially level throughout movement of the carriage between the lower end 14 and the upper end 15 of the rail.

In this particular embodiment, but not necessarily limited thereto, the rail is formed by two tubes 16 and 17 spaced in a vertical plane. The spacing between the tubes is maintained substantially constant by rail brackets 18, opposed ends of the brackets being fixed to the tubes 16 and 17 respectively at various points along the length of the rail. This arrangement in combination with the roller arrangement described below ensures that the general orientation of the carriage is maintained perpendicular to the rail at all positions of the carriage along the rail. Leg supports (not shown) can be attached to two or more of the brackets to mount the rail on a staircase.

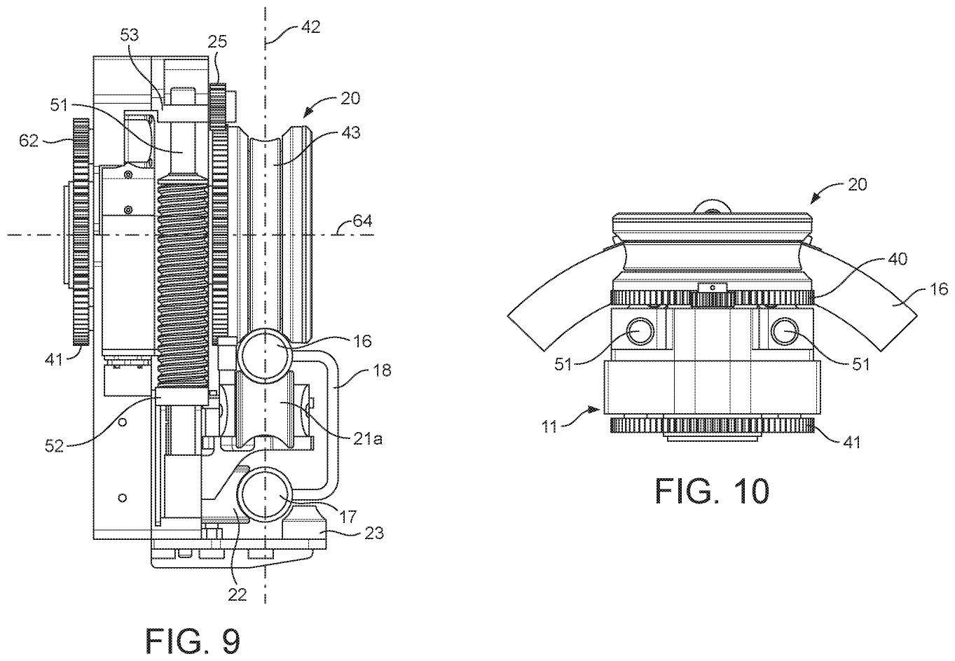

The carriage 11 includes a drive roller 20 and two biasing rollers 21a and 21b to both retain the carriage on the rail and ensure drive is transmitted from the carriage to the rail. In the example shown, the rollers 20, 21a & 21b preferably all act against the upper tube 16 of the rail. Inner support roller 22 (FIG. 9) and outer support roller 23 act against lower rail tube 17 to assist in preventing the carriage pitching forward or rotating about the lengthwise axis 24 of the rail. The roller 23 is shown rotating about a vertical axis in FIG. 9 but it may also be mounted so as to have the ability to pivot about a horizontal axis passing through the axis of rotation of roller 22. This latter feature improves the ability of the carriage to negotiate helical bends.

An important aspect of the invention is that the drive roller 20 imparts drive to the rail 12 by friction. The drive roller is rotated by a pinion 25 mounted on the output shaft of a motor or motor/gearbox unit (not shown) housed within the carriage 11.

In the form shown, the rail has a first horizontal section 26, an inclined section 27 and a second horizontal section 28. The sections 26 and 27 are joined by a positive transition bend 30 while the sections 27 and 28 are joined by a negative transition bend 31. It must be stressed, however, that the particular form of rail shown in FIG. 1 is for illustrative purposes only and the invention may be applied to stairlift rails which have both transition bends as illustrated, inside/outside bends including that shown in FIG. 6, and helical bends that combine vertical and horizontal curvature. In particular, embodiments of the invention have been realised which include a section of rail that terminates in the lower end 14 is substantially vertical such as is shown in International Patent Applications WO 2005/085114 and WO 2017/187161, the contents of both of which are incorporated herein by reference.

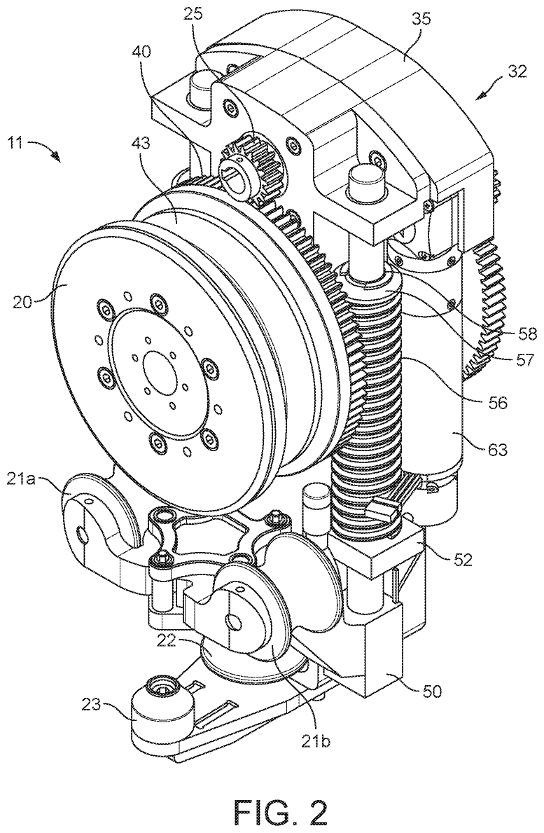

Referring now to FIG. 2, the carriage comprises a housing 32 having a front face 33, a rear face 34, a top surface 35, a bottom surface 36 and spaced side edges 37. Drive roller 20 with integral driving gear 40 is rotatably mounted on the carriage adjacent to the rear face 34 while levelling gear 41 is also rotatably mounted on the carriage but adjacent to the front face 33. In use, chair interface 13, shown partly in FIG. 1, is fixed to the levelling gear 41 for rotation therewith.

As described above, the carriage is retained on the rail, and preferably the top tube 16 of the rail, by drive roller 20 and biasing rollers 21a and 21b, all the rollers preferably being of a diablo profile such that the configurations of the contact surfaces correspond substantially to the profile of the tube 16. The diabolo profile helps retain the carriage on the rail by resisting pitching movement of the carriage and, in the case of drive roller 20, effectively increases the driving surface. A further feature is that a line or plane 42 passing through the vertical centreline of roller 20 passes through the vertical centreline of rail tube 16 as can be seen in FIG. 9. This means that the drive roller does not ‘scrub’ laterally across the rail when passing through inside/outside bends.

In this particular example the biasing rollers 21a, 21b contact the rail at positions diametrically opposed to the contact position of drive roller 20 however this is not essential and suitable support rollers could be positioned elsewhere provided the chosen positions enable the rollers, in combination with a biasing facility, to bias the drive roller 20 against the rail.

The driving surface 43 of the drive roller 20 is preferably formed from a material having a high coefficient of friction. By way of example, the surface 43 may be formed from or covered with polyurethane having a shore hardness lying in the range 92-95. Materials of lesser hardness may be used but those skilled in the art will appreciate that such alternative materials might provide increased friction but also exhibit increased wear. Materials of greater hardness might also be used but would provide less friction while being more resistant to wear.

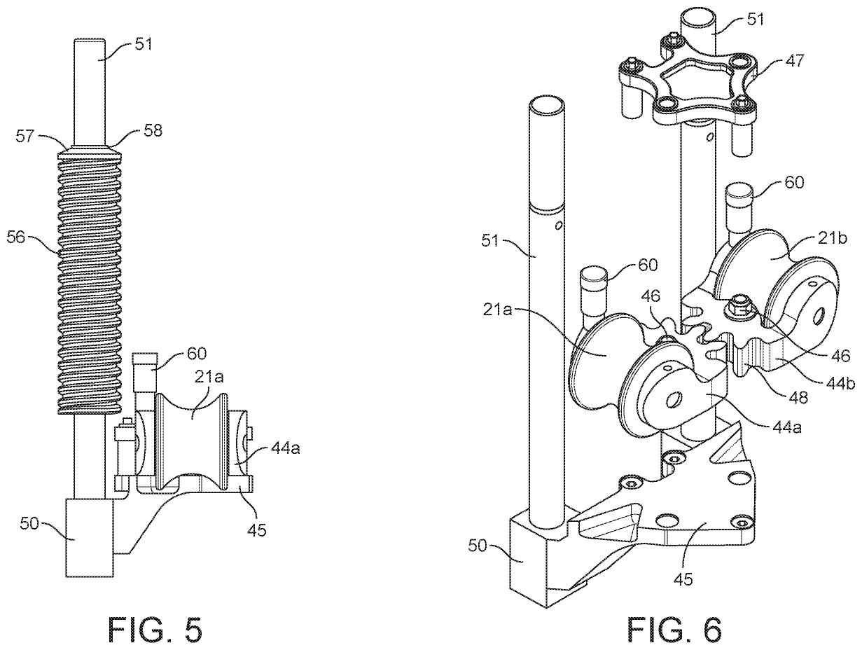

In the particular example depicted and described, the rollers 21a and 21b form part of a sub-assembly that is illustrated more clearly in FIGS. 5 & 6. The rollers 21a and 21b are mounted in roller brackets 44a and 44b respectively, the brackets 44a, 44b being pivotally mounted on base plate 45 by pivot pins 46. The brackets 44a and 44b are retained on the base plate 45 by a closing bracket 47, the plate 45 and closing bracket 47 being configured so that the roller brackets 44a and 44b can rotate freely about their respective pivot pins 46. The axes of pivot pins are preferably positioned mid-way between the centreline of the carriage and the axis of rotation of the associated roller 21a or 21b as the case may be.

It can be seen in FIG. 6 that juxtaposed parts of the brackets 44a and 44b are formed with engaging geared surfaces 48 so that, in use, the pivoting of one of the brackets 44a, 44b about its pivot pin 46 will cause the other of the brackets 44a, 44b to pivot in the opposite direction in a mirror-like manner. This provides a simple roller geometry for negotiating inside/outside bends and helicals while maintaining the drive substantially on the centreline of the rail. Further, the described arrangement provides stability for the carriage on inclined rail sections and, since the root of the drive wheel remains on the rail centreline, the drive roller positively contributes to pitch control on horizontal rail sections.

Located on opposite sides of base plate 45 are pillar blocks 50 from each of which extends a pillar 51. The pillars 51 pass through, and are a sliding fit in, bottom location plates 52 fixed to and extending from sides 37 of the carriage housing, while the upper ends of the pillars are slidably received in upper location plates 53 also projecting from sides 37 of the housing. This arrangement allows the biasing roller set 21a, 21b to be displaced in the direction of, and away from the drive roller 20 in a direction parallel to vertical centreline 55 of the carriage. Biasing means are provided to effect a clamping action of the rollers 20, 21a & 21b toward the rail. In the form shown this biasing means is provided by coil springs 56 which surround the pillars 51, seat on the bottom location plates 52 and are held under compression by retaining plates 57 anchored to the pillars by circlips 58.

As examples of alternatives to the coil springs 56 described, air springs could be used as could linear actuators. In the latter case, the linear actuators could be independently controlled to tailor the clamping force of rollers 20, 21a, 21b on the rail to account for the presence of absence of a user seated on the stairlift, to the weight of a user, and/or to the position of the carriage on the rail.

A further feature of the sub-assembly shown in FIGS. 5 & 6 is the inclusion of additional support rollers 60 extending upwardly from the edges of the roller brackets 44a, 44b and which act against the front edge of the top rail tube 16. At steep rail angles these additional support rollers assist in maintaining the rollers 21a, 21b in contact with the rail.

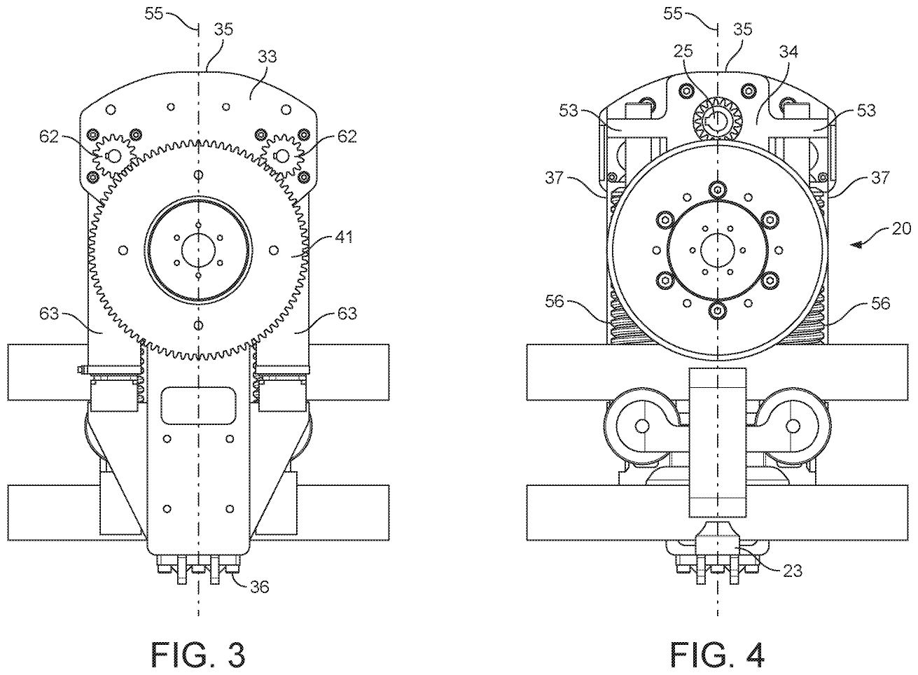

As described above, drive gear 40 is attached to, or forms part of, drive roller 20, and is rotated by drive pinion 25. Levelling gear 41 is, in the form shown, rotated by levelling drive pinions 62 mounted on the outputs of motor/gearbox units 63 positioned adjacent to edges 37 of the carriage housing 32. It can be seen in FIG. 9 that the gears 40 and 41 rotate about a common axis 64 yet are retained within the carriage 11 to rotate independently of one another. Further, the axis of rotation of drive pinion 25 lies on a vertical centreline 55 of the carriage, as can be seen in FIG. 4 while, as can be seen in FIG. 3, the axes of rotation of the levelling drive pinions 62 are positioned to either side of the vertical centreline 55. This arrangement of motors, gears and drives allows for a very compact carriage to be realised.

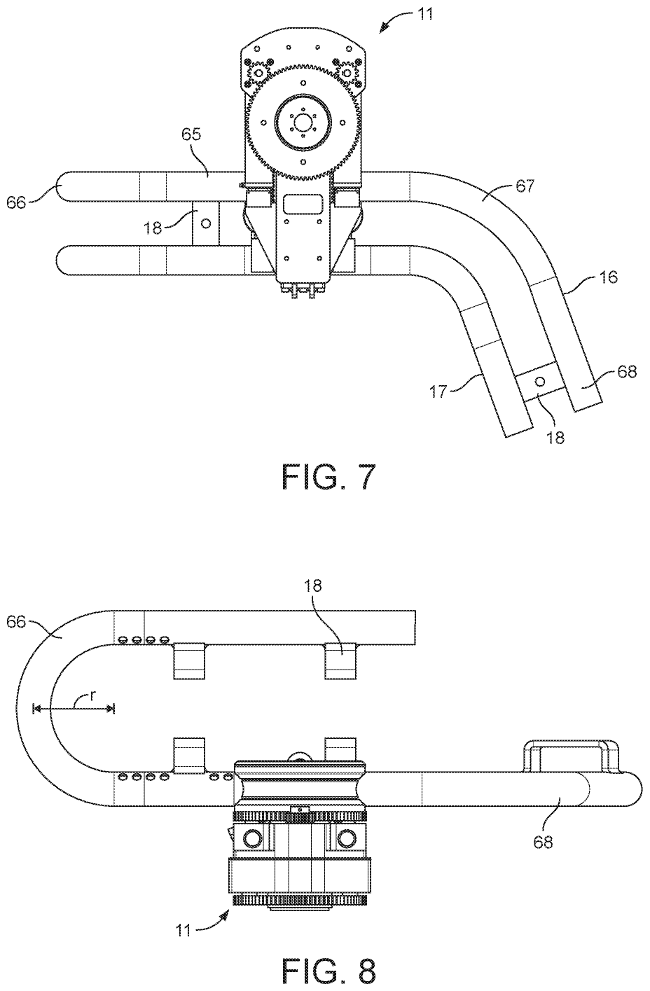

Turning now to FIGS. 7 & 8, carriage 11 is shown mounted on a section of rail that includes a horizontal part 65 including a tight inside bend 66 of radius r to the centreline of the rail, a transition bend 67 and a downwardly extending part 68. Inside bends of the type shown at 66 are often provided at a rail end to allow the carriage to be ‘parked’ off the staircase and is particularly important that this bend be as tight as possible to reduce the spaced occupied by the stairlift. With the friction drive arrangement in the general form described above, inside bends 66 can be achieved of radii tighter than has been achieved heretofore and tighter than can be achieved using rack & pinion drives.

Without in any sense limiting the scope of the invention, an effective stairlift has been constructed having a load capacity of 120 Kg (including load capacity on vertical sections of rail) based on the following dimensions: Rail diameter=44.45 mm; spring force of springs=56-300 Kg each; drive wheel outer diameter=180 mm; drive wheel root diameter=150 mm; radius r=90 mm.

1. A stairlift comprising:
a rail having a length direction axis;
a carriage mounted on said rail for movement there-along; and
a chair mounted on said carriage;
said carriage having a carriage axis that is arranged perpendicular to the direction of the rail at any position of the carriage along the rail;
wherein the carriage is positioned on the rail by a single drive roller configured to frictionally engage the rail and a plurality of biasing rollers in contact with the rail and positioned to maintain the drive roller in contact with the rail, a plane passing through the centre of said drive roller, perpendicular to the axis of rotation of the drive roller, passing through a centreline of the rail at any position of the carriage on the rail;
said carriage further including biasing means to apply a clamping bias effective to clamp said drive roller and said biasing rollers against said rail; and
means to resist rotational movement of said carriage about said length direction axis.

2. The stairlift according to claim 1, wherein said rail is defined by two spaced tubes which, when the rail is mounted for use, are arranged substantially above one another, said drive roller and said biasing rollers engaging opposed edges of one of said tubes.

3. The stairlift according to claim 2, wherein the drive roller and said biasing rollers engage an upper tube of said two spaced tubes.

4. The stairlift according to claim 2, wherein the two tubes are substantially evenly spaced along the length of said rail.

5. The stairlift according to claim 2, wherein said means to resist rotational movement of said carriage about said length direction axis comprises a plurality of support rollers engaging a lower tube of said two spaced tubes.

6. The stairlift according to claim 1, wherein, when viewed in vertical cross-section along said length direction axis, a contact surface of said drive roller has substantially the same form as that part of said rail in contact therewith.

7. The stairlift according to claim 1, further including a levelling facility configured and operable to effect relative rotation between said chair and said carriage as said carriage moves through a bend in said rail in a vertical plane to maintain said chair substantially level.

8. The stairlift according to claim 7, wherein said drive roller rotates about a drive axis and wherein said levelling facility is configured to effect relative rotation between said chair and said carriage about said drive axis, at least one first motor being provided to rotate said drive roller and at least one second motor being provided to effect relative rotation between said chair and said carriage.

9. A stairlift comprising:
a rail having a length direction axis;
a carriage mounted on said rail for movement there-along; and
a chair mounted on said carriage;
said carriage having a carriage axis that is arranged perpendicular to the direction of the rail at any position of the carriage along the rail;
wherein said carriage includes a single drive roller configured to rotate about a drive axis and to frictionally engage said rail; biasing means to bias said drive roller against said rail; and a levelling facility configured to effect relative rotation between said chair and said carriage about said drive axis as said carriage moves through a bend in the rail in a vertical plane, the carriage including at least one first motor to rotate said drive roller and at least one second motor to effect relative rotation between said chair and said carriage independently of said first motor.

10. The stairlift according to claim 9, wherein, said carriage including two second motors to effect rotation of said chair relative to said carriage.

11. The stairlift according to claim 10, wherein, when viewed in a direction along said drive axis, said first motor applies drive substantially on said carriage axis and said two second motors apply drive on opposite sides of said carriage axis.

12. The stairlift according to claim 1, wherein said rail includes a bend that, when viewed in plan view, has a bend radius falling substantially in the range of 90 to 100 mm.

13. The stairlift according to claim 1, wherein said drive roller has a drive surface formed from polyurethane having a shore harness falling in the range 92 to 95.

14. The stairlift according to claim 1, wherein, when mounted in a stairway, said rail has an upper end and a lower end, a section of the rail terminating in said lower end being substantially vertical.
